(19) United States
(12) Patent Application Publication
(10) Pub. No.: US 2017/0153793 A1
(43) Pub. Date: Jun. 1, 2017

(54) METHOD AND APPARATUS FOR APPLICATION ICON MANAGEMENT

(71) Applicant: Xiaomi Inc., Beijing (CN)

(72) Inventors: Ruixian ZHU, Beijing (CN); Guangjian WANG, Beijing (CN); Shuo WANG, Beijing (CN)

(73) Assignee: Xiaomi Inc., Beijing (CN)

(21) Appl. No.: 15/363,573

(22) Filed: Nov. 29, 2016

(30) Foreign Application Priority Data
Nov. 30, 2015 (CN) 201510857523.2

(51) Int. Cl. G06F 3/0481; G06F 3/0488; G09G 5/10; G06F 3/0346

(52) U.S. Cl. CPC G06F 3/04817; G06F 3/0346; G06F 3/0488; G09G 5/10; G09G 2360/144

(57) ABSTRACT

Aspects of the disclosure include a method for application icon management. The method includes detecting, by a sensor, position or motion status of a terminal when the terminal is in a lock screen state; determining whether the position or motion status of the terminal in the lock screen state satisfies a preset status criterion; and lighting up a designated application icon on a lock screen interface of the terminal, when the position or motion status satisfies the preset status criterion.

### CROSS-REFERENCE TO RELATED APPLICATIONS

This application claims priority of the Chinese Patent Application No. 201510857523.2, filed on Nov. 30, 2015, which is incorporated herein by reference in its entirety.

### TECHNICAL FIELD

The present disclosure generally relates to the field of terminal technology, and more particularly, to a method and apparatus for application icon management for a terminal.

### BACKGROUND

Currently, many smart terminals have built-in camera flash devices that can also be used as flashlights. Such flashlights are fairly convenient for terminal users, especially in dark environments. Additionally, a theme interface for a terminal operating system may have shortcut icons provided on its lock screen for quickly launching corresponding functions, such as a dialing function. However, the shortcut icons on the lock screen are fixed and cannot be changed at will.

Some terminal operating systems themselves contain flashlight applications. When the flashlight application is launched, the camera flash device is turned on. Moreover, advanced setting is applied, such as a shortcut button is set so that the flashlight function can be turned on conveniently.

Typically, a user needs to use the flashlight in urgent situations. However, as an infrequently used application, the flashlight application is often buried in piles of applications and cannot be easily found. Therefore, the problem is that it is difficult to find the flashlight application in urgent situations. Although the flashlight may be turned on quickly by setting a shortcut for the flashlight application, not everyone knows the shortcut (few users read the manual completely) and not everybody can keep it in mind.

### SUMMARY

Aspects of the disclosure include a method for application icon management. The method includes detecting, by a sensor, position or motion status of a terminal when the terminal is in a lock screen state; determining whether the position or motion status of the terminal in the lock screen state satisfies a preset status criterion; and lighting up a designated application icon on a lock screen interface of the terminal, when the position or motion status satisfies the preset status criterion.

In an embodiment, In an embodiment, lighting up the designated application icon on the lock screen interface of the terminal includes: obtaining current environment parameter information of an environment in which the terminal is located; and lighting up the designated application icon on the lock screen interface of the terminal, when the current environment parameter information satisfies a preset environment parameter criterion.

In an embodiment, the current environment parameter information comprises at least illumination intensity information and information regarding a distance between the terminal and an obstruction. In an embodiment, lighting up the designated application icon on the lock screen interface of the terminal, when the current environment parameter information satisfies the preset environment parameter criterion, includes, when a current distance between the terminal and the obstruction is greater than or equal to a preset distance and a current illumination intensity is lower than a preset illumination intensity, lighting up a flashlight application icon on the lock screen interface of the terminal.

In an embodiment, lighting up the designated application icon on the lock screen interface of the terminal, when the position or motion status satisfies the preset status criterion, includes, when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, or a detected moving trajectory of the terminal in the lock screen state is consistent with a preset moving trajectory, lighting up the designated application icon on the lock screen interface of the terminal.

In an embodiment, when a number of received touches on the designated application icon is greater than or equal to a preset touch number or a frequency of the touches is greater than or equal to a preset touch frequency, launching the designated application.

In an embodiment, when the designated application icon is not lighted up, the designated application icon is in a hidden state on the lock screen interface of the terminal.

Aspects of the disclosure include an apparatus for application icon management. The apparatus includes a processor and a memory for storing instructions executable by the processor. The processor is configured to: detect, by a sensor, position or motion status of a terminal when the terminal is in a lock screen state; determine whether the position or motion status of the terminal in the lock screen state satisfies a preset status criterion; and light up a designated application icon on a lock screen interface of the terminal when the position or motion status satisfies the preset status criterion.

In an embodiment, the processor is further configured to: obtain current environment parameter information of an environment in which the terminal is located; and light up the designated application icon on the lock screen interface of the terminal, when the current environment parameter information satisfies a preset environment parameter criterion.

In an embodiment, the current environment parameter information comprises at least illumination intensity information and information regarding a distance between the terminal and an obstruction.

In an embodiment, the processor is further configured to, when a current distance between the terminal and the obstruction is greater than or equal to a preset distance and a current illumination intensity is lower than a preset illumination intensity, light up a flashlight application icon on the lock screen interface of the terminal.

In an embodiment, the processor is further configured to, when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, or a detected moving trajectory of the terminal in the lock screen state is consistent with a preset moving trajectory, light up the designated application icon on the lock screen interface of the terminal.

In an embodiment, the processor is further configured to, when a number of received touches on the designated application icon is greater than or equal to a preset touch number or a frequency of the touches is greater than or equal to a preset touch frequency, launch the designated application.

In an embodiment, when the designated application icon is not lighted up, the designated application icon is in a hidden state on the lock screen interface of the terminal.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for application icon management according to an exemplary embodiment.

FIG. 2 is a flow chart showing example steps of a method for application icon management according to an exemplary embodiment.

FIG. 3 is a flow chart showing example steps of a method for application icon management according to an exemplary embodiment.

FIG. 4 is a flow chart showing another method for application icon management according to an exemplary embodiment.

FIG. 5 is a flow chart showing another method for application icon management according to an exemplary embodiment.

FIG. 6 is a block diagram of an apparatus for application icon management according to an exemplary embodiment.

FIG. 7 is a block diagram of a processing module example of an apparatus for application icon management according to an exemplary embodiment.

FIG. 8 is a block diagram of another processing module example of an apparatus for application icon management according to an exemplary embodiment.

FIG. 9 is a block diagram of another apparatus for application icon management according to an exemplary embodiment.

FIG. 10 is a block diagram showing an apparatus for application icon management according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatus and methods consistent with aspects related to the present disclosure.

An embodiment of disclosure provides a method for application icon management, which may be used in a terminal device. As shown in FIG. 1, the method includes steps S101-S103.

In step S101, position or motion status of a terminal when the terminal is in a lock screen state is detected by a sensor. In some examples, the position or motion status may include a status as whether the terminal is being shaken or whether the terminal is being tapped, etc.

In step S102, it is determined whether the position or motion status of the terminal in the lock screen state satisfies a preset status criterion. In some examples, the preset status criterion may include one or more conditions.

In step S103, when the position or motion status satisfies the preset status criterion, a designated application icon is lighted up on a lock screen interface of the terminal. The designated application icon may be an application icon set by the user or preset by the manufacturer on the terminal lock screen interface.

In this embodiment, the position or motion status of the terminal in the lock screen state can be detected by the sensor, and the designated application icon can be lighted up on the lock screen interface of the terminal when the position or motion status satisfies the preset status criterion. As such, a user's needs are determined according to the position or motion status of the terminal, and the needed application is automatically provided on the lock screen interface for the user. Accordingly, the user does not have to be bothered to look for the application and the operation process is simplified, so that the application on the terminal can be utilized more conveniently, easily and rapidly and user experience is improved.

In an embodiment, when the designated application icon is not lighted up, the designated application icon may be displayed or hidden (e.g., in a hidden state).

In the embodiment, when the designated application icon is not lighted up, it may exist on the lock screen interface of the terminal but is hidden (that is, the application icon is invisible to the user), even if the lock screen interface is lighted up by an operation of the user. Only when the position or motion status of the terminal satisfies a preset status criterion, the designated application icon that was hidden is displayed (e.g., being lighted up), so as to facilitate the user's use of the designated application. In some embodiments, when the designated application icon is not lighted up, it may still be associated with but not yet created as a graphic object for the lock screen interface of the terminal.

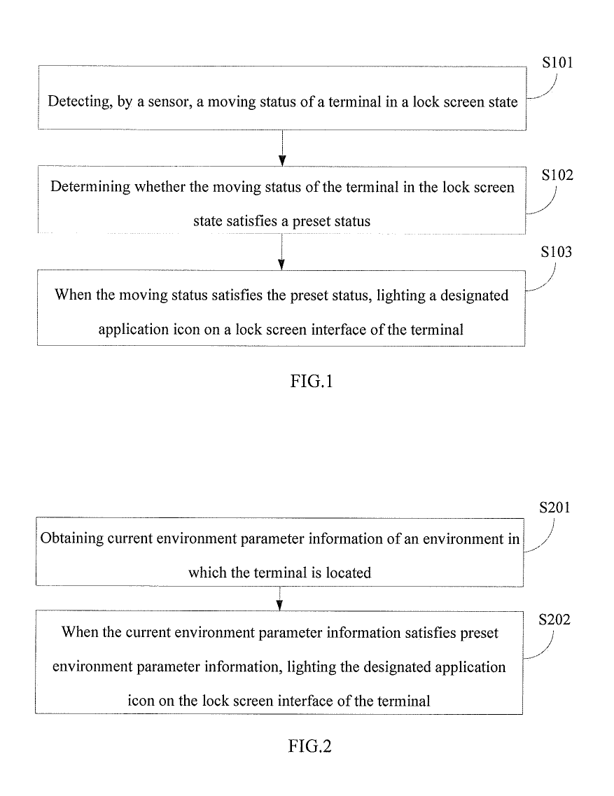

As shown in FIG. 2, in an embodiment, the above step S103 comprises steps S201-S202.

In step S201, current environment parameter information of an environment in which the terminal is located is obtained.

In step S202, when the current environment parameter information satisfies a preset environment parameter criterion, the designated application icon is lighted up on the lock screen interface of the terminal. In some examples, the preset environment parameter criterion may include one or more conditions.

In this embodiment, the current environment parameter information of the environment in which the terminal is located may be obtained, and it is determined based on the environment parameter whether to light up the designated application icon. Specifically, when the current environment parameter information satisfies the preset environment parameter criterion, the designated application icon is lighted up.

In an embodiment, the current environment parameter information comprises at least illumination intensity information and information regarding a distance between the terminal and an obstruction.

In this embodiment, the illumination intensity information and the information on the distance between the terminal and the obstruction may be used to determine whether the current environment parameter information satisfies the preset environment parameter criterion. When the preset environment parameter criterion is satisfied, the designated application icon is lighted up.

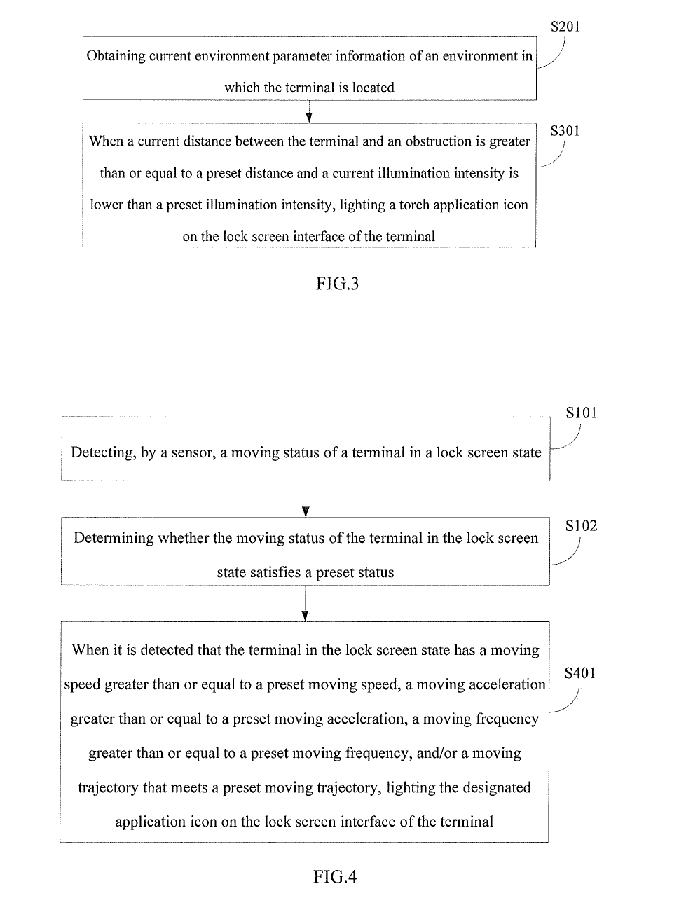

As shown in FIG. 3, in an embodiment, the above step S202 comprises step S301.

In step S301, when the current distance between the terminal and the obstruction is greater than or equal to a preset distance and the current illumination intensity is lower than a preset illumination intensity, the designated application icon is lighted up on the lock screen interface of the terminal.

In this embodiment, when the current distance between the terminal and the obstruction is greater than or equal to the preset distance (i.e. there is no obstruction around the terminal to block light) and the current illumination intensity is lower than the preset illumination intensity (i.e. the brightness around the terminal is rather low), it indicates that the user may need to activate the flashlight function. Then, the flashlight application icon that is hidden on the lock screen interface may be lighted up, so as to make it convenient for the user to turn on the flashlight.

In the above embodiment, the flashlight application is taken as an example. It would be appreciated by those skilled in the art that the designated application icon may also be another application icon for activating or operating a different application, such as a phone application icon, a message application icon, etc. Accordingly, the current environment parameter information may also be some other information, such as ambient noise information, temperature information, humidity information, etc.

As shown in FIG. 4, in an embodiment, the above step S103 may also comprise step S401.

In step S401, when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, and/or a detected moving trajectory of the terminal in the lock screen state is consistent with a preset moving trajectory, the designated application icon is lighted up on the lock screen interface of the terminal.

In this embodiment, the preset status may comprise at least one of: the moving speed of the terminal in the lock screen state being greater than or equal to the preset moving speed, the moving acceleration being greater than or equal to the preset moving acceleration, the moving frequency being greater than or equal to the preset moving frequency, and/or the moving trajectory meeting the preset moving trajectory. For example, when a user rapidly and continuously shakes his terminal, its moving speed, moving acceleration, and moving frequency are greater than respective preset values, and the designated application may be lighted up on the lock screen interface. Alternatively, the preset moving speed may be set as 50 cm/s, and the designated application may be lighted up on the lock screen interface of the terminal when the moving speed exceeds 50 cm/s. Alternatively, the user or the manufacturer may preset a moving trajectory for the terminal, such as a circle, and the designated application may also be lighted up on the lock screen interface when the user draws a circle in the air by moving the terminal. Alternatively, the designated application may be lighted up on the lock screen interface when the user consecutively taps on the screen of the terminal. As such, the terminal can determine a user's needs according to the moving status and automatically provide the needed application on the lock screen interface for the user. Accordingly, the user does not have to be bothered to look for the application and the operation process is simplified, so that the application on the terminal can be utilized more conveniently, easily and rapidly and user experience is improved.

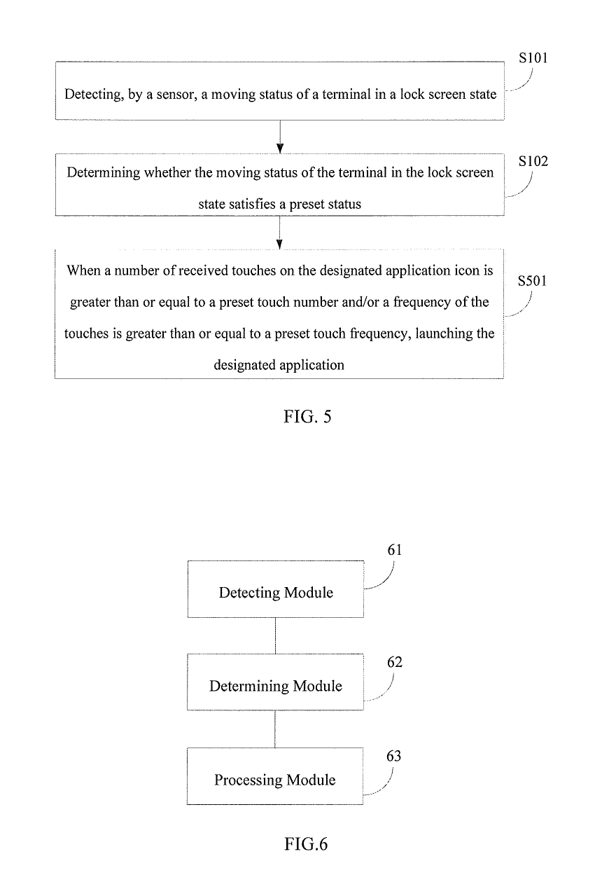

As shown in FIG. 5, in an embodiment, the above method may further comprise step S501.

In step S501, when a number of received touches on the designated application icon is greater than or equal to a preset touch number and/or a frequency of the touches is greater than or equal to a preset touch frequency, the designated application is launched.

In this embodiment, when the number of received touches by the user on the designated application icon is greater than or equal to the preset touch number, the designated application may be launched. For example, the preset touch number may be set as 2, so that when the user double taps the designated application icon, the designated application may be launched. Alternatively, when the frequency of touches by the user on the designated application icon is greater than the preset touch frequency, such as 2 times per second, the designated application may be launched. Of course, these two conditions may be applied in combination, that is, when the number of received touches on the designated application icon is greater than or equal to the preset touch number and the frequency of the touches is greater than or equal to the preset touch frequency, the designated application may be launched. In this manner, the chances of misoperation by the user can be minimized.

In the following, embodiments of apparatus according to the disclosure that can perform the methods described above will be described.

FIG. 6 is a block diagram of an apparatus for application icon management according to an exemplary embodiment. This apparatus may be implemented as a terminal device or a part thereof in form of software, hardware or a combination thereof. As shown in FIG. 6, the apparatus includes a detecting module 61, a determining module 62, and a processing module 63.

The detecting module 61 is configured to detect position or motion status of a terminal by a sensor when the terminal is in a lock screen state. The position or motion status may include a status as whether the terminal is being shaken or whether the terminal is being tapped, etc.

The determining module 62 is configured to determine whether the position or motion status of the terminal in the lock screen state, which is detected by the detecting module 61, satisfies a preset status criterion.

The processing module 63 is configured to light up a designated application icon on a lock screen interface of the terminal when the determining module 62 determines that the position or motion status satisfies the preset status criterion. The designated application icon may be an application icon set by the user or preset by the manufacturer on the terminal lock screen interface.

In this embodiment, the position or motion status of the terminal in the lock screen state can be detected by the sensor, and the designated application icon can be lighted up on the lock screen interface of the terminal when the position or motion status satisfies the preset status criterion. As such, a user's needs are determined according to terminal position or motion status and the needed application is automatically provided on the lock screen interface for the user. Accordingly, the user does not have to be bothered to look for the application and the operation process is simplified, so that the application on the terminal can be utilized more conveniently, easily and rapidly and user experience is improved.

In an embodiment, when the designated application icon is not lighted up, the designated application icon is in a hidden state on the lock screen interface of the terminal.

In the embodiment, when the designated application icon is not lighted up, it exists on the lock screen interface of the terminal but is hidden, that is, the application icon is invisible to the user. Only when the position or motion status of the terminal satisfies a preset status criterion, the designated application icon that was hidden is displayed (e.g., being lighted up), so as to facilitate the user's use of the designated application. In some embodiments, when the designated application icon is not lighted up, it is associated with but not yet created as a graphic object for the lock screen interface of the terminal.

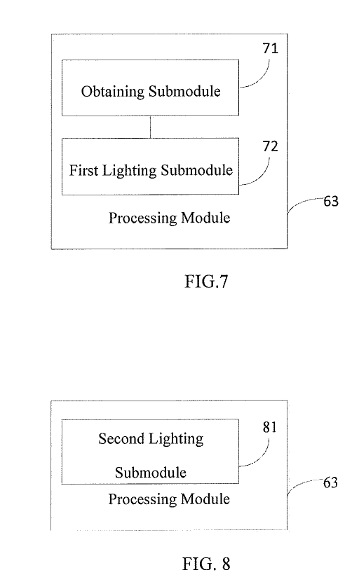

As shown in FIG. 7, in an embodiment, the processing module 63 comprises an obtaining submodule 71 and a first lighting submodule 72.

The obtaining submodule 71 is configured to obtain current environment parameter information of an environment in which the terminal is located.

The first lighting submodule 72 is configured to light up the designated application icon on the lock screen interface of the terminal when the current environment parameter information, which is obtained by the obtaining submodule 71, satisfies a preset environment parameter criterion.

In this embodiment, the current environment parameter information of the environment in which the terminal is located may be obtained, and it is determined whether to light up the designated application icon based on the environment parameter. Specifically, when the current environment parameter information satisfies the preset environment parameter criterion, the designated application icon is lighted up.

In an embodiment, the current environment parameter information comprises at least illumination intensity information and information on a distance between the terminal and an obstruction.

In this embodiment, the illumination intensity information and the information on the distance between the terminal and the obstruction may be used to determine whether the current environment parameter information satisfies the preset environment parameter criterion. When the preset environment parameter criterion is satisfied, the designated application icon is lighted up.

In an embodiment, the first lighting submodule 72 is configured to: light a flashlight application icon on the lock screen interface of the terminal when a current distance between the terminal and the obstruction is greater than or equal to a preset distance and current illumination intensity is lower than a preset illumination intensity.

In this embodiment, when the current distance between the terminal and the obstruction is greater than or equal to the preset distance (i.e. there is no obstruction around the terminal to block light) and the current illumination intensity is lower than the preset illumination intensity (i.e. the brightness level around the terminal is rather low), it indicates that the user may need to use the flashlight. Then, the flashlight application icon that is hidden on the lock screen interface may be lighted up, so as to make it convenient for the user to turn on the flashlight.

In the above embodiment, the flashlight application is taken as an example. It would be appreciated by those skilled in the art that the designated application icon may also be another application icon for activating or operating a different application, such as a phone application icon, a message application icon, etc. Accordingly, the current environment parameter information may also be some other information, such as ambient noise information, temperature information, humidity information, etc.

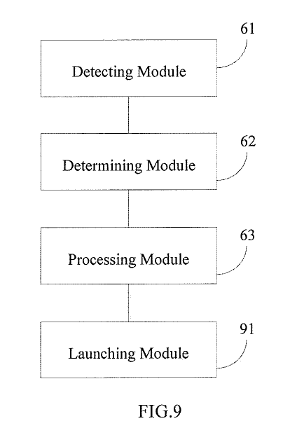

As shown in FIG. 8, in an embodiment, the processing module 63 comprises a second lighting submodule 81.

The second lighting submodule 81 is configured to light up the designated application icon on the lock screen interface of the terminal when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, and/or a detected moving trajectory of the terminal in the lock screen state is consistent with a preset moving trajectory.

In this embodiment, the preset status may comprise at least one of: the moving speed of the terminal in the lock screen state being greater than or equal to the preset moving speed, the moving acceleration being greater than or equal to the preset moving acceleration, the moving frequency being greater than or equal to the preset moving frequency, and/or the moving trajectory meeting a preset moving trajectory. For example, when a user rapidly shakes his terminal, its moving speed, moving acceleration and moving frequency are greater than respective preset values and the designated application may be lighted up on the lock screen interface. Alternatively, the preset moving speed may be set as 50 cm/s, and the designated application may be lighted up on the lock screen interface of the terminal when the moving speed exceeds 50 cm/s. Alternatively, the user or the manufacturer may preset a moving trajectory for the terminal, such as a circle, and the designated application may also be lighted up on the lock screen interface when the user draws a circle in the air by moving the terminal. As such, the terminal can determine a user's needs according to the moving status and automatically provide the needed application on the lock screen interface for the user. Accordingly, the user does not have to be bothered to look for the application and the operation process is simplified, so that the application on the terminal can be utilized more conveniently, easily and rapidly and user experience is improved.

As shown in FIG. 9, in an embodiment, the above apparatus further comprises a launching module 91.

The launching module 91 is configured to launch the designated application when a number of received touches on the designated application icon is greater than or equal to a preset touch number and/or a frequency of the touches is greater than or equal to a preset touch frequency.

In this embodiment, when the number of received touches by the user on the designated application icon is greater than or equal to the preset touch number, the designated application may be launched. For example, the preset touch number may be set as 2, so that when the user double taps the designated application icon the designated application may be launched. Alternatively, when the frequency of touches by the user on the designated application icon is greater than the preset touch frequency, such as 2 times per second, the designated application may be launched. Of course, these two conditions may be applied in combination, that is, when the number of received touches on the designated application icon is greater than or equal to the preset touch number and the frequency of the touches is greater than or equal to the preset touch frequency, the designated application may be launched. In this manner, the chances of misoperation by the user can be minimized.

In accordance with some embodiments of the disclosure, an apparatus for application icon management is provided. The apparatus comprises: a processor; and a memory for storing instructions executable by the processor.

In some examples, the processor is configured to:
detect, by a sensor, position or motion status of a terminal in a lock screen state;
determine whether the position or motion status of the terminal in the lock screen state satisfies a preset status criterion; and
light up a designated application icon on a lock screen interface of the terminal when the position or motion status satisfies the preset status criterion.

The above processor may be further configured such that lighting up the designated application icon on the lock screen interface of the terminal comprises:

obtaining current environment parameter information of an environment in which the terminal is located; and

lighting up the designated application icon on the lock screen interface of the terminal, when the current environment parameter information satisfies a preset environment parameter criterion.

The above processor may be further configured such that the current environment parameter information comprises at least illumination intensity information and information on a distance between the terminal and an obstruction.

The above processor may be further configured such that lighting up the designated application icon on the lock screen interface of the terminal, when the current environment parameter information satisfies the preset environment parameter criterion, comprises:

when a current distance between the terminal and the obstruction is greater than or equal to a preset distance and a current illumination intensity is lower than a preset illumination intensity, lighting up a flashlight application icon on the lock screen interface of the terminal.

The above processor may be further configured such that lighting up the designated application icon on the lock screen interface of the terminal comprises, when the position or motion status satisfies the preset status criterion, comprises: when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, and/or a detected moving trajectory of the terminal in the lock screen state is consistent with a preset moving trajectory, lighting up the designated application icon on the lock screen interface of the terminal.

The above processor may be further configured such that, when a number of received touches on the designated application icon is greater than or equal to a preset touch number and/or a frequency of the touches is greater than or equal to a preset touch frequency, the designated application is launched.

The above processor may be further configured such that, when the designated application icon is not lighted up, the designated application icon is a hidden state on the lock screen interface of the terminal.

It is noted that the various modules, submodules, units, or components described in the present disclosure can be implemented using any suitable technology. In an example, a module, submodule, unit, or component can be implemented using circuitry such as an integrated circuit (IC). In an example, a module, submodule, unit, or component can be implemented as processing circuitry executing software instructions.

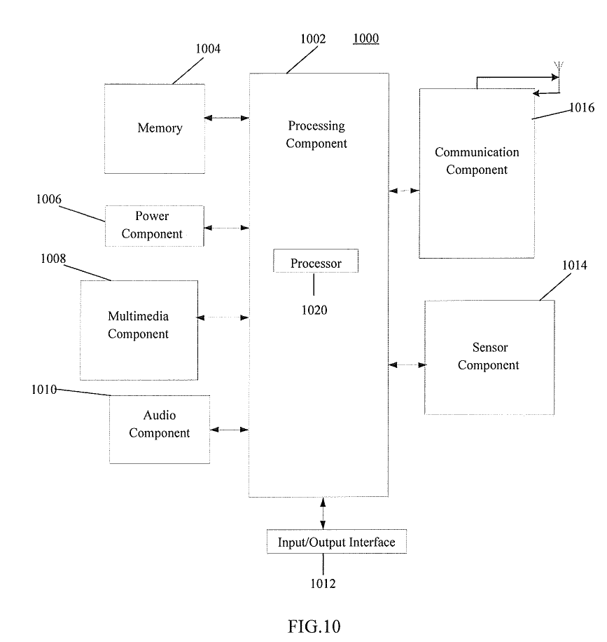

FIG. 10 is a block diagram of an apparatus 1000 for application icon management according to an exemplary embodiment, which may be used in a terminal device. For example, the apparatus 1000 may be a mobile phone, a computer, a digital broadcast terminal, a messaging device, a gaming console, a tablet, a medical device, exercise equipment, a personal digital assistant, and the like.

Referring to FIG. 10, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the apparatus 1000, such as the operations associated with display, telephone calls, data communications, camera operations, and recording operations. The processing component 1002 may include one or more processors 1020 to execute instructions to perform all or part of the steps in the above described methods. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the apparatus 1000. Examples of such data include instructions for any applications or methods operated on the apparatus 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the apparatus 1000. The power component 1006 may include a power management system, one or more power sources, and any other components associated with the generation, management, and distribution of power in the apparatus 1000.

The multimedia component 1008 includes a screen providing an output interface between the apparatus 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1008 includes a front camera and/or a rear camera. The front camera and the rear camera may receive an external multimedia datum while the apparatus 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (“MIC”) configured to receive an external audio signal when the apparatus 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide status assessments of various aspects of the apparatus 1000. For instance, the sensor component 1014 may detect an open/closed status of the apparatus 1000, relative positioning of components, e.g., the display and the keypad, of the apparatus 1000, a change in position of the apparatus 1000 or a component of the apparatus 1000, a presence or absence of user contact with the apparatus 1000, an orientation or an acceleration/deceleration of the apparatus 1000, and a change in temperature of the apparatus 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the apparatus 1000 and other devices. The apparatus 1000 can access a wireless network based on a communication standard, such as WiFi, 2G, or 3G, or a combination thereof. In one exemplary embodiment, the communication component 1016 receives a broadcast signal or broadcast associated information from an external broadcast management system via a broadcast channel. In one exemplary embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1004, executable by the processor 1020 in the apparatus 1000, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium including instructions, which when executed by the processor of the apparatus 1000 cause the apparatus 1000 to perform the above-described method for application icon management. The method comprises: detecting, by a sensor, a position or motion status of a terminal when the terminal is in a lock screen state; determining whether the position or motion status of the terminal in the lock screen state satisfies a preset status criterion; and lighting up a designated application icon on a lock screen interface of the terminal, when the position or motion status satisfies the preset status criterion.

In an embodiment, lighting up the designated application icon on the lock screen interface of the terminal comprises: obtaining current environment parameter information of an environment in which the terminal is located; and lighting up the designated application icon on the lock screen interface of the terminal, when the current environment parameter information satisfies a preset environment parameter criterion.

In an embodiment, the current environment parameter information comprises at least illumination intensity information and information on a distance between the terminal and an obstruction.

In an embodiment, lighting up the designated application icon on the lock screen interface of the terminal, when the current environment parameter information satisfies the preset environment parameter criterion, comprises: when a current distance between the terminal and the obstruction is greater than or equal to a preset distance and current illumination intensity is lower than a preset illumination intensity, lighting up a flashlight application icon on the lock screen interface of the terminal.

In an embodiment, lighting up the designated application icon on the lock screen interface of the terminal, when the moving status satisfies the preset status criterion, comprises: when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, and/or a detected moving trajectory of the terminal in the lock screen state is consistent with a preset moving trajectory, lighting up the designated application icon on the lock screen interface of the terminal.

In an embodiment, the method further comprises: when a number of received touches on the designated application icon is greater than or equal to a preset touch number and/or a frequency of the touches is greater than or equal to a preset touch frequency, launching the designated application.

In an embodiment, when the designated application icon is not lighted up, the designated application icon is in a hidden state on the lock screen interface of the terminal.

Other embodiments of the disclosure will be apparent to those skilled in the art from consideration of the specification and practice of the embodiments disclosed herein. This application is intended to cover any variations, uses, or adaptations of the disclosure following the general principles thereof and including such variations, uses, or adaptations that are not explicitly described in the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof.

1. A method for application icon management, comprising:
detecting, by a sensor, position or motion status of a terminal when the terminal is in a lock screen state;
determining whether the position or motion status of the terminal in the lock screen state satisfies a preset status criterion; and
lighting up a designated application icon on a lock screen interface of the terminal, when the position or motion status satisfies the preset status criterion.

2. The method of claim 1, wherein lighting up the designated application icon on the lock screen interface of the terminal comprises:
obtaining current environment parameter information of an environment in which the terminal is located; and
lighting up the designated application icon on the lock screen interface of the terminal, when the current environment parameter information satisfies a preset environment parameter criterion.

3. The method of claim 2, wherein the current environment parameter information comprises at least illumination intensity information and information regarding a distance between the terminal and an obstruction.

4. The method of claim 3, wherein lighting up the designated application icon on the lock screen interface of the terminal, when the current environment parameter information satisfies the preset environment parameter criterion, comprises:
when a current distance between the terminal and the obstruction is greater than or equal to a preset distance and a current illumination intensity is lower than a preset illumination intensity, lighting up a flashlight application icon on the lock screen interface of the terminal.

5. The method of claim 1, wherein lighting up the designated application icon on the lock screen interface of the terminal, when the position or motion status satisfies the preset status criterion, comprises:
when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, or a detected moving trajectory of the terminal in the lock screen state is consistent with a preset moving trajectory, lighting up the designated application icon on the lock screen interface of the terminal.

6. The method of claim 1, further comprising:
when a number of received touches on the designated application icon is greater than or equal to a preset touch number or a frequency of the touches is greater than or equal to a preset touch frequency, launching the designated application.

7. The method of claim 1, wherein when the designated application icon is not lighted up, the designated application icon is in a hidden state on the lock screen interface of the terminal.

8. The method of claim 2, wherein when the designated application icon is not lighted up, the designated application icon is in a hidden state on the lock screen interface of the terminal.

9. The method of claim 3, wherein when the designated application icon is not lighted up, the designated application icon is in a hidden state on the lock screen interface of the terminal.

10. The method of claim 4, wherein when the designated application icon is not lighted up, the designated application icon is in a hidden state on the lock screen interface of the terminal.

11. The method of claim 5, wherein when the designated application icon is not lighted up, the designated application icon is in a hidden state on the lock screen interface of the terminal.

12. The method of claim 6, wherein when the designated application icon is not lighted up, the designated application icon is in a hidden state on the lock screen interface of the terminal.

13. An apparatus for application icon management, comprising:
a processor; and
a memory for storing instructions executable by the processor,
wherein the processor is configured to:
detect, by a sensor, position or motion status of a terminal when the terminal is in a lock screen state;
determine whether the position or motion status of the terminal in the lock screen state satisfies a preset status criterion; and
light up a designated application icon on a lock screen interface of the terminal when the position or motion status satisfies the preset status criterion.

14. The apparatus of claim 13, wherein the processor is further configured to:
obtain current environment parameter information of an environment in which the terminal is located; and
light up the designated application icon on the lock screen interface of the terminal, when the current environment parameter information satisfies a preset environment parameter criterion.

15. The apparatus of claim 14, wherein the current environment parameter information comprises at least illumination intensity information and information regarding a distance between the terminal and an obstruction.

16. The apparatus of claim 15, wherein the processor is further configured to:
when a current distance between the terminal and the obstruction is greater than or equal to a preset distance and a current illumination intensity is lower than a preset illumination intensity, light up a flashlight application icon on the lock screen interface of the terminal.

17. The apparatus of claim 13, wherein the processor is further configured to:
when a detected moving speed of the terminal in the lock screen state is greater than or equal to a preset moving speed, a detected moving acceleration of the terminal in the lock screen state is greater than or equal to a preset moving acceleration, a detected moving frequency of the terminal in the lock screen state is greater than or equal to a preset moving frequency, or a detected moving trajectory of the terminal in the lock screen state is consistent with a preset moving trajectory, light up the designated application icon on the lock screen interface of the terminal.

18. The apparatus of claim 13, wherein the processor is further configured to:
when a number of received touches on the designated application icon is greater than or equal to a preset touch number or a frequency of the touches is greater than or equal to a preset touch frequency, launch the designated application.

19. The apparatus of claim 13, wherein when the designated application icon is not lighted up, the designated application icon is in a hidden state on the lock screen interface of the terminal.

20. The apparatus of claim 16, wherein when the designated application icon is not lighted up, the designated application icon is in a hidden state on the lock screen interface of the terminal.
